(19) United States
(12) Patent Application Publication
(10) Pub. No.: US 2026/0054821 A1
(43) Pub. Date: Feb. 26, 2026

(54) COMPOSITE THERMAL MANAGEMENT SYSTEM FOR ELECTRIC SHIP

(71) Applicant: SCS CO., LTD., Sejong-si (KR)

(72) Inventors: Mi Hye KWON, Sejong-si (KR); Hyang Jong HONG, Sejong-si (KR)

(73) Assignee: SCS CO., LTD., Sejong-si (KR)

(21) Appl. No.: 19/307,169

(22) Filed: Aug. 22, 2025

(30) Foreign Application Priority Data
Aug. 23, 2024 (KR) 20-2024-0001563

(51) Int. Cl. B63J 2/04; B60H 1/00; B63J 2/12

(52) U.S. Cl. CPC B63J 2/04; B60H 1/00278; B60H 1/00885; B63J 2/12; B60H 2001/00935; B60H 2001/00942

(57) ABSTRACT

Disclosed is a composite thermal management system for an electric ship capable of maximizing the performance of a battery through efficient thermal management of a cabin, a battery, and a motor, and selectively switching between cooling and heating by a heat pump control method. The composite thermal management system for an electric ship selectively cools or heats a cabin, a battery, and a motor equipped in the electric ship, and includes a first heating and cooling unit that selectively switches a circulation cycle of a refrigerant according to a cooling or heating mode to cool or heat an inside of the cabin and a second heating and cooling unit that cools and heats the battery and the motor using coolant heat-exchanged with the refrigerant.

### CROSS-REFERENCE TO RELATED APPLICATIONS

This application claims the benefit of Korean Patent Application No. 20-2024-0001563, filed on Aug. 23, 2024, in the Korean Intellectual Property Office, the disclosures of which are incorporated herein in their entirety by reference.

### TECHNICAL FIELD

The present utility model relates to a composite thermal management system for an electric ship, and more particularly, to a composite thermal management system for an electric ship capable of cooling or heating passenger rooms, batteries, and motors of the electric ship.

### BACKGROUND

In order to reduce greenhouse gas emissions, regulations and laws are being strengthened worldwide.

In particular, as 80% of global merchandise trade is transported by ships, regulations on greenhouse gas emissions from ports and maritime areas are also being strengthened.

The existing ships are operated using fossil fuels such as diesel, and thus emit a large amount of exhaust gases such as fine dust, nitrogen oxides, soot, sulfur oxides, and carbon dioxide, thereby polluting the atmospheric environment.

Accordingly, technology development and commercialization of eco-friendly ships to meet environmental regulations on emissions of air pollutants have been actively conducted.

The eco-friendly ships include LNG ships, fuel cell ships, hybrid ships, and electric ship.

Compared to other eco-friendly ships (LNG ships, hybrid ships, etc.), the electric ship do not use fossil fuels at all and operate by driving motors powered by electricity from batteries as a power source, so they may not emit air pollutants and may reduce fuel costs by using relatively inexpensive electric energy compared to fossil fuels.

In addition, the electric ship does not have engine facilities that are large in size and weight, unlike mechanical ships, so they may reduce the overall weight of the ships and increase space efficiency.

In addition, the electric ship uses motors powered by electric energy as their power source, so they operate quietly with much less noise and vibration than diesel engines, and since the electric ship only require connecting cables to supply electricity, they have the advantage of great design flexibility regarding the installation locations of the electric motor and propeller set.

In addition, the electric ship has the advantage of much better speed control capability than the existing diesel engine ships because the rotation speed of the motor is very easy to adjust.

Meanwhile, the electric ship uses electric energy from batteries to operate and control all of the ship's facilities, so they require a large number of batteries.

However, since the increase in batteries increases the weight of the ship and the overall cost of the ship, the number of batteries is inevitably limited in reality.

In addition, since the capacity of the battery is directly related to a sailing distance of the electric ship, charging is essential to overcome the short sailing distance.

However, there is a realistic limit to the installation of charging infrastructure to overcome the short sailing distance.

Therefore, there is an urgent need for technology development that can improve the performance and efficiency of batteries equipped in electric ship.

### SUMMARY

The present utility model provides a composite thermal management system for an electric ship capable of maximizing the performance of a battery through efficient thermal management of a cabin, a battery, and a motor.

In addition, the present utility model provides a composite thermal management system for an electric ship capable of performing thermal management through cooling/heating up of air and thermal management by heat-exchanging of a coolant in a composite manner.

In addition, the present utility model provides a composite thermal management system for an electric ship capable of selectively switching between cooling and heating through a heat pump control method.

In addition, the present utility model provides a composite thermal management system for an electric ship capable of implementing high-efficiency heating performance without using a heater.

In addition, the present utility model provides a composite thermal management system for an electric ship capable of performing integrated thermal management of a cabin, a battery, and a motor of the electric ship through a single composite thermal management system.

Meanwhile, objects of the present utility model are not limited to the above-mentioned objects. That is, other objects that are not described may be obviously understood by those skilled in the art from the following specification.

According to an aspect of the present utility model, a composite thermal management system for an electric ship selectively cooling or heating a cabin, a battery, and a motor equipped in an electric ship includes: a first heating and cooling unit that selectively switches a circulation cycle of a refrigerant according to a cooling or heating mode to cool or heat an inside of the cabin; and a second heating and cooling unit that cools and heats the battery and the motor using coolant heat-exchanged with the refrigerant.

The first heating and cooling unit may control the circulation cycle of the refrigerant so that, during the cooling mode, a high-temperature, high-pressure refrigerant is converted into a low-temperature, low-pressure refrigerant, and cools air introduced into the cabin and coolant introduced into the second heating and cooling unit, and control the circulation cycle of the refrigerant so that, during the heating mode, the high-temperature, high-pressure refrigerant heats the air introduced into the cabin and the coolant introduced into the second heating and cooling unit, and then is converted into the low-temperature, low-pressure refrigerant, and the second heating and cooling unit may expose cold air of the coolant cooled by exchanging heat with the low-temperature, low-pressure refrigerant to the motor during the cooling mode to cool the motor, and expose hot air of the coolant heated by exchanging heat with the high-temperature, high-pressure refrigerant to the motor during the heating mode to heat the motor.

The first heating and cooling unit may include: a compressor that compresses the refrigerant to form the refrigerant into a high temperature and high pressure state; a 4-way valve that discharges the high-temperature, high-pressure refrigerant compressed by the compressor in a first direction during the cooling mode and in a second direction during the heating mode; a condenser that forms, the high-temperature, high-pressure refrigerant introduced thereinto, into a liquid state by exchanging heat with an outside during the cooling mode and forms, the low-temperature, low-pressure refrigerant introduced thereinto, into a gaseous state by exchanging heat with the outside during the heating mode; an evaporator that heat-exchanges the low-temperature, low-pressure refrigerant introduced thereinto with the air supplied to an inside of the cabin during the cooling mode to cool the air supplied to the inside of the cabin, and heat-exchanges the high-temperature, high-pressure refrigerant introduced thereinto with the air supplied to the inside of the cabin during the heating mode to heat the air supplied to the inside of the cabin; a chiller that heat-exchanges the low-temperature, low-pressure refrigerant introduced thereinto with the coolant flowing into the second heating and cooling unit during the cooling mode to cool the coolant while forming the low-temperature, low-pressure refrigerant into the gaseous state, and heat-exchanges the high-temperature, high-pressure refrigerant introduced thereinto with the coolant flowing into the second heating and cooling unit during the heating mode to heat the coolant while forming the high-temperature, high-pressure refrigerant into the liquid state; a first expansion valve that is arranged between the condenser and the evaporator, and forms the high-temperature, high-pressure refrigerant flowing from the condenser to the evaporator into a low-temperature, low-pressure state during the cooling mode, and forms the high-temperature, high-pressure refrigerant flowing from the evaporator to the condenser into the low-temperature, low-pressure state during the heating mode; a second expansion valve that is arranged between the condenser and the chiller, and forms the high-temperature, high-pressure refrigerant flowing from the condenser to the chiller into the low-temperature, low-pressure state during the cooling mode, and forms the high-temperature, high-pressure refrigerant flowing from the chiller to the condenser into the low-temperature, low-pressure state during the heating mode; a liquid separator that is arranged between the 4-way valve and the compressor to separate a liquid refrigerant and introduce only a gaseous refrigerant into the compressor; and a refrigerant flow line that interconnects the compressor, the 4-way valve, the condenser, the evaporator, the chiller, the first expansion valve, the second expansion valve, and the liquid separator, and forms a preset flow path of the refrigerant according to the cooling or heating mode.

The refrigerant flow line may include: a first refrigerant line that connects the compressor and the 4-way valve; a second refrigerant line that connects the 4-way valve and the condenser; a third refrigerant line that connects the condenser and the first expansion valve; a fourth refrigerant line that connects the first expansion valve and the evaporator; a fifth refrigerant line that connects the evaporator and the 4-way valve; a sixth refrigerant line that connects the condenser and the second expansion valve; a seventh refrigerant line that connects the second expansion valve and the chiller; an eighth refrigerant line the connects the chiller and the 4-way valve; a ninth refrigerant line that connects the 4-way valve and the liquid separator; and a tenth refrigerant line that connects the liquid separator and the compressor.

When the composite thermal management system is set to the cooling mode, the refrigerant in the high-temperature, high-pressure gas state compressed by the compressor may be introduced into the 4-way valve through the first refrigerant line, the refrigerant in the high-temperature, high-pressure gas state discharged in the first direction from the 4-way valve may be introduced into the condenser through the second refrigerant line, a portion of a refrigerant formed in a high-temperature, high-pressure liquid state in the condenser may be introduced into the first expansion valve through the third refrigerant line and another portion of the refrigerant may be introduced into the second expansion valve through the sixth refrigerant line, a refrigerant formed in a low-temperature, low-pressure wet steam state in the first expansion valve may be introduced into the evaporator through the fourth refrigerant line, a refrigerant formed in a low-temperature, low-pressure gas state by cooling the air supplied from the evaporator to the inside of the cabin may be introduced into the 4-way valve through the fifth refrigerant line, the refrigerant formed in the low-temperature, low-pressure wet steam state in the second expansion valve may be introduced into the chiller through the seventh refrigerant line, a refrigerant formed in a low-temperature, low-pressure gas state by cooling the coolant flowing from the chiller to the second heating and cooling unit may be introduced into the 4-way valve through the eighth refrigerant line, the refrigerant in the low-temperature, low-pressure gas state introduced into the 4-way valve may be introduced into the liquid separator through the ninth refrigerant line, and the refrigerant in the low-temperature, low-pressure gas state passing through the liquid separator may be introduced into the compressor through the tenth refrigerant line and compressed into the high-temperature, high-pressure gas state.

When the composite thermal management system is set to the heating mode, the refrigerant in the high-temperature, high-pressure gas state compressed by the compressor may be introduced into the 4-way valve through the first refrigerant line, a portion of the refrigerant in the high-temperature, high-pressure gas state discharged in the second direction from the 4-way valve may be introduced into the evaporator through the fifth refrigerant line and another portion of the refrigerant may be introduced into the chiller through the eighth refrigerant line, the refrigerant formed into the high-temperature, high-pressure liquid state by heating the air supplied from the evaporator to the inside of the cabin may be introduced into the first expansion valve through the fourth refrigerant line, refrigerant the formed into the low-temperature, low-pressure wet steam state in the first expansion valve may be introduced into the condenser through the third refrigerant line, the refrigerant formed into the high-temperature, high-pressure liquid state by heating the coolant flowing from the chiller to the second heating and cooling unit may be introduced into the second expansion valve through the seventh refrigerant line, the refrigerant formed into the low-temperature, low-pressure wet steam state: in the second expansion valve may be introduced into the condenser through the sixth refrigerant line, the refrigerant formed into the low-temperature, low-pressure gas state by exchanging heat with the outside in the condenser may be introduced into the 4-way valve through the second refrigerant line, the refrigerant in the low-temperature, low-pressure gas state introduced into the 4-way valve may be introduced into the liquid separator through the ninth refrigerant line, and the refrigerant in the low-temperature, low-pressure gas state passing through the liquid separator may be introduced into the compressor through the tenth refrigerant line and compressed into a high-temperature, high-pressure gas state.

The composite thermal management system may further include: a refrigerant heat exchanger that induces a phase change of the refrigerant by exchanging heat with auxiliary coolant flowing thereinto and the refrigerant flowing into the condenser, in which the refrigerant heat exchanger may discharge, to the outside, hot air of the auxiliary coolant heated by exchanging heat with the high-temperature, high-pressure refrigerant introduced into the condenser during the cooling mode, and discharge to the outside cold air of the auxiliary coolant cooled by exchanging heat with the low-temperature, low-pressure refrigerant introduced into the condenser during the heating mode.

The refrigerant heat exchanger may include: an auxiliary coolant flow line that is connected to the condenser, and has the auxiliary coolant heat-exchanged with the refrigerant flowing into the condenser, circulating therethrough; an auxiliary coolant storage tank that is installed in the auxiliary coolant flow line, and has the auxiliary coolant, which is cooled or heated by exchanging heat with the refrigerant flowing into the condenser, stored therein; an auxiliary coolant circulation pump that is installed in the auxiliary coolant flow line and circulates the auxiliary coolant in one direction; and an auxiliary coolant heat exchange radiator that is installed in the auxiliary coolant flow line to discharge the hot air of the auxiliary coolant heated during the cooling mode to an outside space and discharge the cold air of the auxiliary coolant cooled during the heating mode to the outside space.

The second heating and cooling unit may include: a first heat exchanger that is connected to the chiller, and has a first coolant, which is cooled and heated by exchanging heat with the refrigerant flowing into the chiller, flowing therethrough; and a second heat exchanger that is connected to the first heat exchanger, has a second coolant, which is cooled or heated by exchanging heat with the first coolant flowing into the first heat exchanger, flowing therethrough, and cools or heats the battery and the motor using the second coolant, and the second heat exchanger may cool the motor by exposing the cold air of the second coolant cooled by exchanging heat with the first coolant to the motor during the cooling mode, and heat the motor by exposing the hot air of the second coolant heated by exchanging heat with the first coolant to the motor during the heating mode.

The first heat exchanger may include: a first coolant line that is connected to the chiller, and has the first coolant cooled or heated by exchanging heat with the refrigerant flowing into the chiller, circulating therethrough; a first coolant storage tank that is installed in the first coolant line, and stores the first coolant flowing into the first coolant line; and a first coolant circulation pump that is installed in the first coolant line and circulates the first coolant in one direction.

The first heat exchanger may further include a battery heating and cooling unit that is equipped with the battery and cools or heats the battery by exposing the first coolant, which is heat-exchanged with the second coolant, to the battery.

The second heat exchanger may include: a second coolant line that is connected to the first coolant line, and has the second coolant, which is cooled or heated by exchanging heat with the first coolant flowing into the first coolant line, circulating therethrough; a heat exchange module that is installed in the second coolant line, connected to the first coolant line, and cools or heats the second coolant flowing thereinto by exchanging heat with the second coolant and the first coolant introduced thereinto; a radiator that is installed in the second coolant line, and discharges the cold air or the hot air of the second coolant passing through the heat exchange module to the outside space, or cools or heats the battery with the cold air or the hot air of the second coolant; a second coolant storage tank that is installed in the second coolant line, and stores the second coolant passing through the radiator; a second coolant circulation pump that is installed in the second coolant line and circulates the second coolant in one direction; and a motor heating and cooling unit that is equipped with the motor and exposes the motor to the second coolant passing through the radiator to cool or heat the motor.

The first coolant line may include: a main coolant line that is connected to the chiller and has the first coolant storage tank and the first coolant circulation pump installed therein; a first branch line that is branched in a first direction from the main coolant line, connected to the first coolant circulation pump, and has the battery heating and cooling unit installed therein; and a second branch line that is branched in a second direction from the main coolant line, arranged parallel to the first branch line, connected to the first coolant circulation pump, and has the battery heating and cooling unit installed therein, and the second heat exchanger may be arranged in the first branch line and the second branch line, respectively.

### BRIEF DESCRIPTION OF THE DRAWINGS

FIG. 1 is a conceptual diagram schematically illustrating a composite thermal management system for an electric ship according to an embodiment of the present utility model.

FIG. 2 is a diagram showing a refrigerant cycle of the composite thermal management system for an electric ship during cooling mode.

FIG. 3 is a diagram illustrating the refrigerant cycle of the composite thermal management system for an electric ship during heating mode.

### DETAILED DESCRIPTION OF EMBODIMENTS

Hereinafter, embodiments will be described in detail with reference to the accompanying drawings. However, embodiments may be modified in various ways, and the scope of rights of the utility model registration application is not limited or restricted by these embodiments. It should be understood that all modifications, equivalents, or substitutes for the embodiments are included in the scope of the rights.

Specific structural or functional descriptions of embodiments are disclosed for illustrative purposes only and may be modified and implemented in various forms. Therefore, embodiments are not limited to specific disclosed forms, and the scope of the present specification includes modifications, equivalents, or substitutes included in the technical idea.

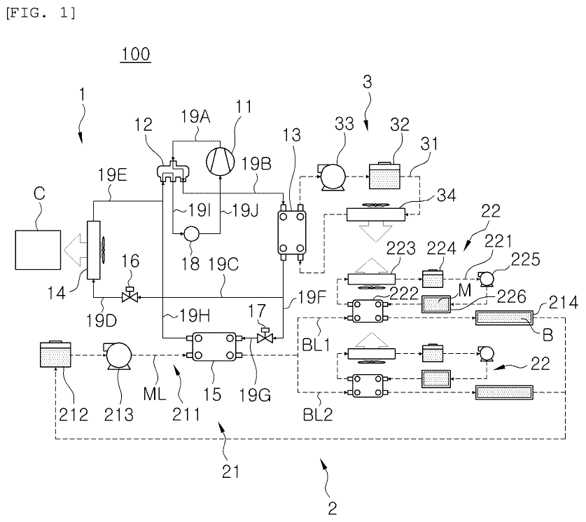

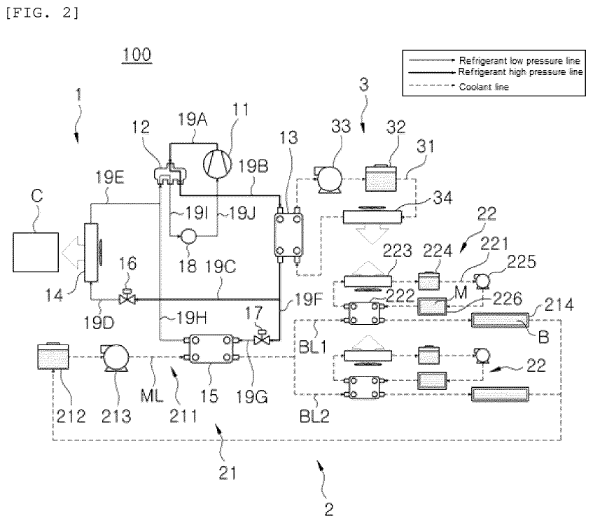

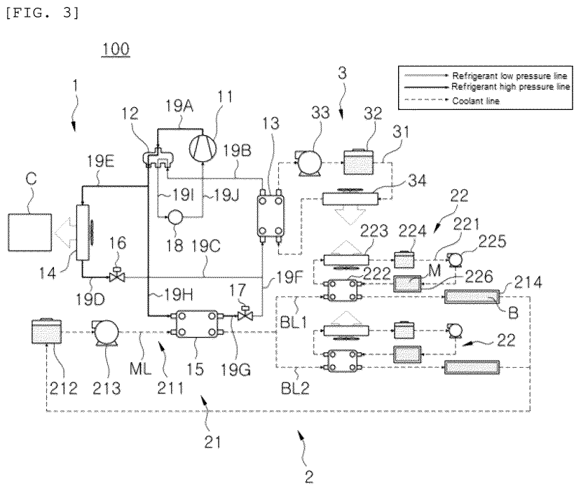

FIG. 1 is a conceptual diagram schematically illustrating a composite thermal management system for an electric ship according to an embodiment of the present utility model, FIG. 2 is a diagram illustrating a refrigerant cycle of the composite thermal management system for an electric ship during cooling mode, and FIG. 3 is a diagram illustrating a refrigerant cycle of a composite thermal management system for an electric ship during heating mode.

Referring to FIGS. 1 to 3, a composite thermal management system 100 for an electric ship (hereinafter referred to as ‘composite thermal management system 100’ for an electric ship’) according to an embodiment of the present utility model selectively cools or heats a cabin C, a battery B, and a motor M provided in the electric ship, and includes a first heating and cooling unit 1 and a second heating and cooling unit 2.

The first heating and cooling unit 1 selectively switches a circulation cycle of a refrigerant according to the cooling or heating mode to cool or heat the inside of the cabin C.

The first heating and cooling unit 1 controls the circulation cycle of the refrigerant so that, during the cooling mode, a high-temperature, high-pressure refrigerant is converted into a low-temperature, low-pressure refrigerant, and the air introduced into the cabin C and the coolant flowing into the second heating and cooling unit 2 are cooled.

In addition, the first heating and cooling unit 1 controls the circulation cycle of the refrigerant so that, during the heating mode, the high-temperature, high-pressure refrigerant heats the air introduced into the cabin C and the coolant flowing into the second heating and cooling unit 2, and then is converted into the low-temperature, low-pressure refrigerant.

The first heating and cooling unit 1 may include a compressor 11, a 4-way valve 12, a condenser 13, an evaporator 14, a chiller 15, a first expansion valve 16, a second expansion valve 17, a liquid separator 18, and a refrigerant flow line 19.

The compressor 11 may compress the low-temperature, low-pressure refrigerant introduced thereinto to form the low-temperature, low-pressure refrigerant into the high-temperature, high-pressure state.

In this case, the refrigerant compressed by the compressor 11 may be a gaseous refrigerant.

For example, the compressor 11 may be a compressor applied to a typical cooling system.

The 4-way valve 12 may discharge the high-temperature, high-pressure refrigerant compressed by the compressor 11 in a first direction during the cooling mode, and in a second direction during the heating mode.

The 4-way valve 12 has four connection ports and may be implemented as the conventional 4-way valve 12 that selectively switches the circulation cycle of the refrigerant.

For example, the 4-way valve 12 may be configured to have a piston or a slide valve inside to control the flow of the refrigerant, or to operate a pilot valve when current flows through an electronic coil, and thus move a piston of the main body to change an inlet and an outlet of the refrigerant.

The condenser 13 may form, the high-temperature, high-pressure refrigerant introduced thereinto, into a liquid state by exchanging heat with the outside during the cooling mode. In addition, the condenser 13 may form, the low-temperature, low-pressure refrigerant introduced thereinto, into a gaseous state by exchanging heat with the outside during the heating mode.

That is, the condenser 13 may change its role according to the applied cooling or heating mode.

Therefore, the condenser 13 may function as a condensation and heating means that forms a refrigerant in a high-temperature, high-pressure gas state into a liquid state by exchanging heat with the outside during the cooling mode, and may function as an evaporation and coolant means that cools a refrigerant in a low-temperature, low-pressure wet steam state to form the refrigerant into the gaseous state by exchanging heat with the outside during the heating mode.

In this case, the condenser 13 operated during the heating mode may perform the same function as the chiller 15 during the cooling mode.

For example, the condenser 13 may be a water-cooled condensing device. However, the condenser 13 is not necessarily limited thereto, and may be implemented as a condensing device of another type.

The evaporator 14 may cool the air supplied to the inside of the cabin C by heat-exchanging the air supplied to the inside of the cabin C with the low-temperature, low-pressure refrigerant introduced thereinto during the cooling mode. In addition, the evaporator 14 may heat the air supplied to the inside of the cabin C by heat-exchanging the air supplied to the inside of the cabin C with the high-temperature, high-pressure refrigerant introduced thereinto during the heating mode.

That is, the evaporator 14 may change its role according to the cooling or heating mode applied.

Therefore, the evaporator 14 may function as the evaporation means that cools air by exchanging heat between the refrigerant in the low-temperature, low-pressure wet steam state and the air during the cooling mode to form the refrigerant into a gaseous state, and may function as a condensation means that heats air by exchanging heat between a refrigerant in a high-temperature, high-pressure gas state and air during the heating mode to form the refrigerant into a liquid state.

The chiller 15 may cool the coolant by exchanging heat between the low-temperature, low-pressure refrigerant introduced thereinto during the cooling mode and the coolant flowing through the second heating and cooling unit 2 to form the refrigerant into the gaseous state. In addition, the chiller 15 may heat the coolant by exchanging heat between the high-temperature, high-pressure refrigerant introduced thereinto during the heating mode and the coolant flowing into the second heating and cooling unit 2 to form the refrigerant into the liquid state.

That is, the chiller 15 may change its role according to the applied cooling or heating mode.

Therefore, the chiller 15 may function as an evaporation and coolant means that cools the coolant by exchanging heat with the coolant during the cooling mode to form the refrigerant in the low-temperature, low-pressure wet steam into the gaseous state, and may function as a condensation and heating means that heats the coolant by exchanging heat with the coolant during the heating mode to form the refrigerant in the high-temperature, high-pressure gas into the liquid state.

In this case, the chiller 15 operated during the heating mode may perform the same function as the condenser 13 during the cooling mode.

The first expansion valve 16 may be arranged between the condenser 13 and the evaporator 14.

The first expansion valve 16 may form the high-temperature, high-pressure refrigerant flowing from the condenser 13 to the evaporator 14 during the cooling mode into a low-temperature, low-pressure state, and may form the high-temperature, high-pressure refrigerant flowing from the evaporator 14 to the condenser 13 during the heating mode into the low-temperature, low-pressure state.

That is, the first expansion valve 16 may reduce the pressure of the refrigerant introduced thereinto and control a flow rate of the discharged refrigerant to form the refrigerant in the high-temperature, high-pressure liquid state into the refrigerant in the low-temperature, low-pressure wet steam state.

The second expansion valve 17 may be arranged between the condenser 13 and the chiller 15.

The second expansion valve 17 may form the high-temperature, high-pressure refrigerant flowing from the condenser 13 to the chiller 15 during the cooling mode into a low-temperature, low-pressure state, and may form the high-temperature, high-pressure refrigerant flowing from the chiller 15 to the condenser 13 during the heating mode into the low-temperature, low-pressure state.

That is, the second expansion valve 17 may reduce the pressure of the refrigerant introduced thereinto and control a flow rate of the discharged refrigerant to form the refrigerant in the high-temperature, high-pressure liquid state into the refrigerant in the low-temperature, low-pressure wet steam state.

The liquid separator 18 is arranged between the 4-way valve 12 and the compressor 11 to separate the liquid refrigerant and introduce only the gaseous refrigerant into the compressor 11.

The refrigerant flow line 19 may interconnect the compressor 11, the 4-way valve 12, the condenser 13, the evaporator 14, the chiller 15, the first expansion valve 16, the second expansion valve 17, and the liquid separator 18.

The refrigerant flow line 19 may form a preset flow path of the refrigerant according to the cooling or heating mode.

Meanwhile, although not specifically illustrated in the drawings, control valves that open and close the flow path of the refrigerant flow line 19 according to the cooling or heating mode, respectively, may be arranged in the refrigerant flow line 19 to form the flow path of the refrigerant.

The refrigerant flow line 19 may include a first refrigerant line 19A connecting the compressor 11 and the 4-way valve 12, a second refrigerant line 19B connecting the 4-way valve 12 and the condenser 13, and a third refrigerant line 19C connecting the condenser 13 and the first expansion valve 16.

In addition, the refrigerant flow line 19 may further include a fourth refrigerant line 19D connecting the first expansion valve 16 and the evaporator 14, a fifth refrigerant line 19E connecting the evaporator 14 and the 4-way valve 12, and a sixth refrigerant line 19F connecting the condenser 13 and the second expansion valve 17.

In addition, the refrigerant flow line 19 may further include a seventh refrigerant line 19G connecting the second expansion valve 17 and the chiller 15, an eighth refrigerant line 19H connecting the chiller 15 and the 4-way valve 12, a ninth refrigerant line 19I connecting the 4-way valve 12 and the liquid separator 18, and a tenth refrigerant line 19J connecting the liquid separator 18 and the compressor 11. Therefore, when the composite thermal management system 100 is set to the cooling mode, the refrigerant in the high-temperature, high-pressure gas state compressed by the compressor 11 may be introduced into the 4-way valve 12 through the first refrigerant line 19A. In addition, the refrigerant in the high-temperature, high-pressure gas state discharged in the first direction from the 4-way valve 12 may be introduced into the condenser 13 through the second refrigerant line 19B. In addition, a portion of the refrigerant formed in the high-temperature, high-pressure liquid state in the condenser 13 may be introduced into the first expansion valve 16 through the third refrigerant line 19C, and another part of the refrigerant formed in the high-temperature, high-pressure liquid state in the condenser 13 may be introduced into the second expansion valve 17 through the sixth refrigerant line 19F. In addition, the refrigerant formed in the low-temperature, low-pressure wet steam state in the first expansion valve 16 may be introduced into the evaporator 14 through the fourth refrigerant line 19D. In addition, the refrigerant formed in the low-temperature, low-pressure gas state by cooling the air supplied to the inside of the cabin C from the evaporator 14 may be introduced into the 4-way valve 12 through the fifth refrigerant line 19E. In addition, the refrigerant formed in the low-temperature, low-pressure wet steam state from the second expansion valve 17 may be introduced into the chiller 15 through the seventh refrigerant line 19G. In addition, the refrigerant formed in the low-temperature, low-pressure gas state by cooling the coolant flowing into the second heating and cooling unit 2 from the chiller 15 may be introduced into the 4-way valve 12 through the eighth refrigerant line 19H. In addition, the refrigerant in the low-temperature, low-pressure gas state introduced through the 4-way valve 12 may be introduced into the liquid separator 18 through the ninth refrigerant line 19I. In addition, the refrigerant in the low-temperature, low-pressure gas state that has passed through the liquid separator 18 may be introduced into the compressor 11 through the tenth refrigerant line 19J and compressed into the high-temperature, high-pressure gas state.

That is, when the composite thermal management system 100 is set to the cooling mode, the high temperature and high pressure refrigerant may flow through the first refrigerant line 19A, the second refrigerant line 19B, the third refrigerant line 19C, and the sixth refrigerant line 19F, and the low temperature and low pressure refrigerant may flow through the fourth refrigerant line 19D, the fifth refrigerant line 19E, the seventh refrigerant line 19G, the eighth refrigerant line 19H, the ninth refrigerant line 19I, and the tenth refrigerant line 19J.

Conversely, when the composite thermal management system 100 is set to the heating mode, the refrigerant in the high-temperature, high-pressure gas state compressed by the compressor 11 may be introduced into the 4-way valve 12 through the first refrigerant line 19A. In addition, a portion of the refrigerant in the high-temperature, high-pressure gas state discharged in the second direction from the 4-way valve 12 may be introduced into the evaporator 14 through the fifth refrigerant line 19E, and another portion of the refrigerant in the high-temperature, high-pressure gas state discharged in the second direction from the 4-way valve 12 may be introduced into the chiller 15 through the eighth refrigerant line 19H. In addition, the refrigerant formed into the high-temperature, high-pressure liquid state by heating the air supplied from the evaporator 14 to the inside of the cabin C may be introduced into the first expansion valve 16 through the fourth refrigerant line 19D. In addition, the refrigerant formed into the low-temperature, low-pressure wet steam state from the first expansion valve 16 may be introduced into the condenser 13 through the third refrigerant line 19C. In addition, the refrigerant formed into the high-temperature, high-pressure liquid state by heating the coolant flowing into the second heating and cooling unit 2 from the chiller 15 may be introduced into the second expansion valve 17 through the seventh refrigerant line 19G. In addition, the refrigerant formed in the low-temperature, low-pressure wet steam state in the second expansion valve 17 may be introduced into the condenser 13 through the sixth refrigerant line 19F. In addition, the refrigerant formed in the low-temperature, low-pressure gas state by exchanging heat with the outside in the condenser 13 may be introduced into the 4-way valve 12 through the second refrigerant line 19B. In addition, the refrigerant in the low-temperature, low-pressure gas state introduced through the 4-way valve 12 may be introduced into the liquid separator 18 through the ninth refrigerant line 19I. In addition, the refrigerant in the low-temperature, low-pressure gas state that has passed through the liquid separator 18 may be introduced into the compressor 11 through the tenth refrigerant line 19J and compressed into the high-temperature, high-pressure gas state.

That is, when the composite thermal management system 100 is set to the heating mode, the high temperature and high pressure refrigerant may flow through the first refrigerant line 19A, the fourth refrigerant line 19D, the fifth refrigerant line 19E, the seventh refrigerant line 19G, and the eighth refrigerant line 19H, and the low temperature and low pressure refrigerant may flow through the second refrigerant line 19B, the third refrigerant line 19C, the sixth refrigerant line 19F, the ninth refrigerant line 19I, and the tenth refrigerant line 19J.

The composite thermal management system 100 for an electric ship may further include a refrigerant heat exchanger 3.

The refrigerant heat exchanger 3 may induce the phase change of the refrigerant by exchanging heat between the auxiliary coolant flowing thereinto and the refrigerant flowing into the condenser 13.

The refrigerant heat exchanger 3 may be configured to discharge hot air of the auxiliary coolant heated by exchanging heat with the high-temperature, high-pressure refrigerant introduced into the condenser 13 to the outside during the cooling mode, and to discharge cold air of the auxiliary coolant cooled by exchanging heat with the low-temperature, low-pressure refrigerant introduced into the condenser 13 to the outside during the heating mode.

The refrigerant heat exchanger 3 may include an auxiliary coolant flow line 31, an auxiliary coolant storage tank 32, an auxiliary coolant circulation pump 33, and an auxiliary coolant heat exchange radiator 34.

The auxiliary coolant flow line 31 may be connected to the condenser 13.

The auxiliary coolant flow line 31 may circulate the auxiliary coolant that has been heat-exchanged with the refrigerant flowing into the condenser 13.

More specifically, during the cooling mode, the heated auxiliary coolant may flow into the auxiliary coolant flow line 31, and during the heating mode, the cooled auxiliary coolant may flow into the auxiliary coolant flow line 31.

The auxiliary coolant storage tank 32 is installed in the auxiliary coolant flow line 31, and the cooled or heated auxiliary coolant may be stored by exchanging heat with the refrigerant flowing into the condenser 13.

For example, the auxiliary coolant storage tank 32 may be implemented as a conventional reservoir tank that alleviates a change in volume of the coolant according to temperature, etc., and discharges air that prevents the flow of the auxiliary coolant within the refrigerant heat exchanger 3.

The auxiliary coolant circulation pump 33 is installed in the auxiliary coolant flow line 31, and may circulate the auxiliary coolant in one direction.

The auxiliary coolant heat exchange radiator 34 may be installed in the auxiliary coolant flow line 31.

The auxiliary coolant heat exchange radiator 34 may discharge the hot air of the heated auxiliary coolant to the outside space during the cooling mode, and may the discharge cold air of the cooled auxiliary coolant to the outside space during the heating mode.

For example, the auxiliary coolant heat exchange radiator 34 may include a radiator body in which the auxiliary coolant flow thereinto, and a cooling fan that passes air through the radiator body to discharge the hot air or cold air of the auxiliary coolant flowing into the radiator body to the outside space.

The second heating and cooling unit 2 cools or heats a battery B and a motor M using the coolant that has been heat-exchanged with the refrigerant.

The second heating and cooling unit 2 may cool the motor M by exposing the cold air of the coolant, which has been cooled by exchanging heat with the low-temperature, low-pressure refrigerant during the cooling mode, to the motor M.

In addition, the second heating and cooling unit 2 may heat the motor M by exposing the hot air of the coolant, which has been heated by exchanging heat with the high-temperature, high-pressure refrigerant during the heating mode, to the motor M.

The second heating and cooling unit 2 may include a first heat exchanger 21 and a second heat exchanger 22.

The first heat exchanger 21 may be connected to the chiller 15.

The first coolant, which is cooled or heated by exchanging heat with the refrigerant flowing into the chiller 15, may flow into the first heat exchanger 21.

The first heat exchanger 21 may include a first coolant line 211, a first coolant storage tank 212, and a first coolant circulation pump 213.

The first coolant line 211 may be connected to the chiller 15.

The first coolant cooled or heated by exchanging heat with the refrigerant flowing into the chiller 15 may be circulated through the first coolant line 211.

More specifically, the first coolant cooled by exchanging heat with the chiller 15 during the cooling mode may be circulated through the first coolant line 211. In addition, the first coolant heated by exchanging heat with the chiller 15 during the heating mode may be circulated through the first coolant line 211.

The first coolant storage tank 212 may be installed in the first coolant line 211. The first coolant flowing into the first coolant line 211 may be stored in the first coolant storage tank 212.

For example, the first coolant storage tank 212 may be implemented as the conventional reservoir tank that alleviates the change in the volume of the coolant due to temperature, etc., and discharges air within the first coolant line 211.

The first coolant circulation pump 213 is installed in the first coolant line 211 and may circulate the first coolant in one direction.

The first heat exchanger 21 may further include a battery heating and cooling unit 214.

The battery heating and cooling unit 214 may be equipped with the battery B.

The battery heating and cooling unit 214 may expose the first coolant, which has been heat-exchanged with the second coolant, to the battery B to cool or heat the battery B.

For example, the battery heating and cooling unit 214 means a battery coolant unit that is equipped with batteries B and directly cools the batteries B by contacting the batteries B or indirectly cools the batteries B by being separated from the batteries B.

The second heat exchanger 22 may be connected to the first heat exchanger 21.

A second coolant cooled or heated by exchanging heat with the first coolant flowing into the first heat exchanger 21 may flow into the second heat exchanger 22.

The second heat exchanger 22 may cool or heat the battery B and the motor M by using the second coolant.

In this case, the second heat exchanger 22 may cool the motor M by exposing the cold air of the second coolant, which is cooled by exchanging heat with the first coolant during the cooling mode, to the motor M. In addition, the second heat exchanger 22 may heat the motor M by exposing the hot air of the second coolant heated by exchanging heat with the first coolant during the heating mode to the motor M.

The second heat exchanger 22 may include a second coolant line 221, a heat exchange module 222, a radiator 223, a second coolant storage tank 224, a second coolant circulation pump 225, and a motor heating and cooling unit 226.

The second coolant line 221 may be connected to the first coolant line 211.

The second coolant cooled or heated by exchanging heat with the first coolant flowing into the first coolant line 211 may be circulated inside the second coolant line 221.

The heat exchange module 222 may be installed in the second coolant line 221 and connected to the first coolant line 211.

The heat exchange module 222 may cool or heat the second coolant flowing thereinto by exchanging heat with the first coolant introduced thereinto.

More specifically, the heat exchange module 222 may cool the second coolant by exchanging heat between the second coolant flowing thereinto with the first coolant introduced thereinto during the cooling mode. In addition, the heat exchange module 222 may heat the second coolant by exchanging heat between the second coolant flowing thereinto with the first coolant introduced thereinto during the heating mode.

That is, the heat exchange module 222 may change its role according to the applied cooling or heating mode.

Therefore, the heat exchange module 222 may perform the role of the cooling means that cools the second coolant by exchanging heat with the first coolant during the cooling mode, and may perform the role of the heating means that heats the second coolant by exchanging heat with the first coolant during the heating mode.

The radiator 223 may be installed in the second coolant line 221.

The radiator 223 may be configured to discharge the cold air or hot air of the second coolant that has passed through the heat exchange module 222 together with the heat of the motor M to the outside space, or to discharge the cold air or hot air of the second coolant to the space where the battery B is accommodated or toward the battery B, thereby cooling or heating up the battery B.

For example, the radiator 223 may include a radiator body into which the second coolant flows, and a cooling fan that discharges the hot air or cold air of the second coolant flowing into the radiator body by passing air through the radiator body.

The second coolant storage tank 224 may be installed in the second coolant line 221.

The second coolant storage tank 224 may store the second coolant that has passed through the radiator 223.

For example, the second coolant storage tank 224 may be implemented as the conventional reservoir tank that alleviates the change in the volume of the coolant due to temperature, etc., and discharges air within the second coolant line 221.

The second coolant circulation pump 225 is installed in the second coolant line 221 and may circulate the second coolant in one direction.

The motor M may be mounted on the motor heating and cooling unit 226.

The motor heating and cooling unit 226 may cool or heat up the motor M by exposing the second coolant that has passed through the radiator 223 to the motor M.

For example, the motor heating and cooling unit 226 means the cooling means of the motor M that is equipped with the motor M and directly cools the motor M by contacting the motor M or indirectly cools the motor M by being separated from the motor M.

The first coolant line 211 may include a main coolant line ML, a first branch line BL1, and a second branch line BL2.

A main coolant line ML may be connected to the chiller 15.

The first coolant storage tank 212 and the first coolant circulation pump 213 may be installed on the main coolant line ML.

The first branch line BL1 may be branched from the main coolant line ML in the first direction and connected to the first coolant circulation pump 213.

The battery heating and cooling unit 214 may be installed in the first branch line BL1.

The second branch line BL2 may be branched from the main coolant line ML in the second direction and may be arranged in parallel with the first branch line BL1.

The second branch line BL2 may be connected to the first coolant circulation pump 213.

The battery heating and cooling unit 214 may be installed in the second branch line BL2.

In this case, the second heat exchanger 22 may be arranged in the first branch line BL1 and the second branch line BL2, respectively.

That is, the composite thermal management system 100 for an electric ship forms branch lines arranged in a parallel structure to the first coolant line 211, and arranges the second heat exchanger 22 in each of the branch lines arranged in a parallel structure, thereby efficiently performing thermal management for a large number of batteries B and motors M.

According to an embodiment of the present utility model, since the efficient thermal management of the battery B is possible through the composite thermal management system 100 that selectively cools or heats the cabin C, the battery B, and the motor M, it is possible to improve the performance and efficiency of the battery B, thereby increasing the sailing distance of the electric ship and reducing the installation cost of the battery B.

In addition, since the thermal management target is directly exposed to the coolant to perform the thermal management while supplying the cooled or heated air to the thermal management target, it is possible to maximize the thermal management performance.

In addition, since the cooling or heating may be selectively switched through the heat pump control method, it is possible to achieve the high cooling and heating effect compared to the power consumption, and since the cooling and heating may be implemented simultaneously with one thermal management system, it is possible to increase the energy efficiency and save the installation space.

Although the embodiments of the present utility model have been described in more detail with reference to the attached drawings, the present utility model is not necessarily limited to these embodiments, and may be variously modified and implemented within a scope that does not depart from the technical spirit of the present utility model. Accordingly, exemplary embodiments disclosed in the present utility model are not to limit the spirit of the present utility model, but are to describe the spirit of the present utility model. The scope of the present utility model is not limited to these exemplary embodiments. Therefore, it should be understood that the above-mentioned embodiments are exemplary in all aspects but are not limited thereto. The scope of the present utility model should be interpreted by the following claims and it should be interpreted that all spirits equivalent to the following claims fall within the scope of the present utility model.

Therefore, other implementations, other embodiments, and equivalents of the claims are within the scope of the following claims.

What is claimed is:

1. A composite thermal management system for selectively cooling or heating a cabin, a battery, and a motor equipped in an electric ship, comprising:
a first heating and cooling unit that selectively switches a circulation cycle of a refrigerant according to a cooling or heating mode to cool or heat an inside of the cabin; and
a second heating and cooling unit that cools and heats the battery and the motor using coolant heat-exchanged with the refrigerant.

2. The composite thermal management system of claim 1, wherein the first heating and cooling unit controls the circulation cycle of the refrigerant so that, during the cooling mode, a high-temperature, high-pressure refrigerant is converted into a low-temperature, low-pressure refrigerant, and cools air introduced into the cabin and coolant introduced into the second heating and cooling unit, and
controls the circulation cycle of the refrigerant so that, during the heating mode, the high-temperature, high-pressure refrigerant heats the air introduced into the cabin and the coolant introduced into the second heating and cooling unit, and then is converted into the low-temperature, low-pressure refrigerant, and
the second heating and cooling unit exposes cold air of the coolant cooled by exchanging heat with the low-temperature, low-pressure refrigerant to the motor during the cooling mode to cool the motor, and
expose hot air of the coolant heated by exchanging heat with the high-temperature, high-pressure refrigerant to the motor during the heating mode to heat the motor.

3. The composite thermal management system of claim 2, wherein the first heating and cooling unit includes:
a compressor that compresses the refrigerant to form the refrigerant into a high temperature and high pressure state;
a 4-way valve that discharges the high-temperature, high-pressure refrigerant compressed by the compressor in a first direction during the cooling mode and in a second direction during the heating mode;
a condenser that forms, the high-temperature, high-pressure refrigerant introduced thereinto, into a liquid state by exchanging heat with an outside during the cooling mode and forms, the low-temperature, low-pressure refrigerant introduced thereinto, into a gaseous state by exchanging heat with the outside during the heating mode;
an evaporator that heat-exchanges the low-temperature, low-pressure refrigerant introduced thereinto with the air supplied to an inside of the cabin during the cooling mode to cool the air supplied to the inside of the cabin, and heat-exchanges the high-temperature, high-pressure refrigerant introduced thereinto with the air supplied to the inside of the cabin during the heating mode to heat the air supplied to the inside of the cabin;
a chiller that heat-exchanges the low-temperature, low-pressure refrigerant introduced thereinto with the coolant flowing into the second heating and cooling unit during the cooling mode to cool the coolant while forming the low-temperature, low-pressure refrigerant into the gaseous state, and heat-exchanges the high-temperature, high-pressure refrigerant introduced thereinto with the coolant flowing into the second heating and cooling unit during the heating mode to heat the coolant while forming the high-temperature, high-pressure refrigerant into the liquid state;
a first expansion valve that is arranged between the condenser and the evaporator, and forms the high-temperature, high-pressure refrigerant flowing from the condenser to the evaporator into a low-temperature, low-pressure state during the cooling mode, and forms the high-temperature, high-pressure refrigerant flowing from the evaporator to the condenser into the low-temperature, low-pressure state during the heating mode;
a second expansion valve that is arranged between the condenser and the chiller, and forms the high-temperature, high-pressure refrigerant flowing from the condenser to the chiller into the low-temperature, low-pressure state during the cooling mode, and forms the high-temperature, high-pressure refrigerant flowing from the chiller to the condenser into the low-temperature, low-pressure state during the heating mode;
a liquid separator that is arranged between the 4-way valve and the compressor to separate a liquid refrigerant and introduce only a gaseous refrigerant into the compressor; and
a refrigerant flow line that interconnects the compressor, the 4-way valve, the condenser, the evaporator, the chiller, the first expansion valve, the second expansion valve, and the liquid separator, and forms a preset flow path of the refrigerant according to the cooling or heating mode.

4. The composite thermal management system of claim 3, wherein the refrigerant flow line includes:
a first refrigerant line that connects the compressor and the 4-way valve;
a second refrigerant line that connects the 4-way valve and the condenser;
a third refrigerant line that connects the condenser and the first expansion valve;
a fourth refrigerant line that connects the first expansion valve and the evaporator;
a fifth refrigerant line that connects the evaporator and the 4-way valve;
a sixth refrigerant line that connects the condenser and the second expansion valve;
a seventh refrigerant line that connects the second expansion valve and the chiller;
an eighth refrigerant line the connects the chiller and the 4-way valve;
a ninth refrigerant line that connects the 4-way valve and the liquid separator; and
a tenth refrigerant line that connects the liquid separator and the compressor.

5. The composite thermal management system of claim 4, wherein, when the composite thermal management system is set to the cooling mode,
the refrigerant in the high-temperature, high-pressure gas state compressed by the compressor is introduced into the 4-way valve through the first refrigerant line, the refrigerant in the high-temperature, high-pressure gas state discharged in the first direction from the 4-way valve is introduced into the condenser through the second refrigerant line, a portion of a refrigerant formed in a high-temperature, high-pressure liquid state in the condenser is introduced into the first expansion valve through the third refrigerant line and another portion of the refrigerant is introduced into the second expansion valve through the sixth refrigerant line, a refrigerant formed in a low-temperature, low-pressure wet steam state in the first expansion valve is introduced into the evaporator through the fourth refrigerant line, a refrigerant formed in a low-temperature, low-pressure gas state by cooling the air supplied from the evaporator to the inside of the cabin is introduced into the 4-way valve through the fifth refrigerant line, the refrigerant formed in the low-temperature, low-pressure wet steam state in the second expansion valve is introduced into the chiller through the seventh refrigerant line, a refrigerant formed in a low-temperature, low-pressure gas state by cooling the coolant flowing from the chiller to the second heating and cooling unit is introduced into the 4-way valve through the eighth refrigerant line, the refrigerant in the low-temperature, low-pressure gas state introduced into the 4-way valve is introduced into the liquid separator through the ninth refrigerant line, and the refrigerant in the low-temperature, low-pressure gas state passing through the liquid separator is introduced into the compressor through the tenth refrigerant line and compressed into the high-temperature, high-pressure gas state; and
when the composite thermal management system is set to the heating mode,
the refrigerant in the high-temperature, high-pressure gas state compressed by the compressor is introduced into the 4-way valve through the first refrigerant line, a portion of the refrigerant in the high-temperature, high-pressure gas state discharged in the second direction from the 4-way valve is introduced into the evaporator through the fifth refrigerant line and another portion of the refrigerant is introduced into the chiller through the eighth refrigerant line, the refrigerant formed into the high-temperature, high-pressure liquid state by heating the air supplied from the evaporator to the inside of the cabin is introduced into the first expansion valve through the fourth refrigerant line, the refrigerant formed into the low-temperature, low-pressure wet steam state in the first expansion valve is introduced into the condenser through the third refrigerant line, the refrigerant formed into the high-temperature, high-pressure liquid state by heating the coolant flowing from the chiller to the second heating and cooling unit is introduced into the second expansion valve through the seventh refrigerant line, the refrigerant formed into the low-temperature, low-pressure wet steam state in the second expansion valve is introduced into the condenser through the sixth refrigerant line, the refrigerant formed into the low-temperature, low-pressure gas state by exchanging heat with the outside in the condenser is introduced into the 4-way valve through the second refrigerant line, the refrigerant in the low-temperature, low-pressure gas state introduced into the 4-way valve is introduced into the liquid separator through the ninth refrigerant line, and the refrigerant in the low-temperature, low-pressure gas state passing through the liquid separator is introduced into the compressor through the tenth refrigerant line and compressed into a high-temperature, high-pressure gas state.

6. The composite thermal management system of claim 4, further comprising:
a refrigerant heat exchanger that induces a phase change of the refrigerant by exchanging heat with auxiliary coolant flowing thereinto and the refrigerant flowing into the condenser;
wherein the refrigerant heat exchanger discharges, to the outside, hot air of the auxiliary coolant heated by exchanging heat with the high-temperature, high-pressure refrigerant introduced into the condenser during the cooling mode, and
discharge, to the outside, cold air of the auxiliary coolant cooled by exchanging heat with the low-temperature, low-pressure refrigerant introduced into the condenser during the heating mode.

7. The composite thermal management system of claim 6, wherein the refrigerant heat exchanger includes:
an auxiliary coolant flow line that is connected to the condenser, and has the auxiliary coolant heat-exchanged with the refrigerant flowing into the condenser, circulating therethrough;
an auxiliary coolant storage tank that is installed in the auxiliary coolant flow line, and has the auxiliary coolant, which is cooled or heated by exchanging heat with the refrigerant flowing into the condenser, stored therein;
an auxiliary coolant circulation pump that is installed in the auxiliary coolant flow line and circulates the auxiliary coolant in one direction; and
an auxiliary coolant heat exchange radiator that is installed in the auxiliary coolant flow line to discharge the hot air of the auxiliary coolant heated during the cooling mode to an outside space and discharge the cold air of the auxiliary coolant cooled during the heating mode to the outside space.

8. The composite thermal management system of claim 3, wherein the second heating and cooling unit includes:
a first heat exchanger that is connected to the chiller, and has a first coolant, which is cooled and heated by exchanging heat with the refrigerant flowing into the chiller, flowing therethrough; and
a second heat exchanger that is connected to the first heat exchanger, has a second coolant, which is cooled or heated by exchanging heat with the first coolant flowing into the first heat exchanger, flowing therethrough, and cools or heats the battery and the motor using the second coolant, and
the second heat exchanger cools the motor by exposing the cold air of the second coolant cooled by exchanging heat with the first coolant to the motor during the cooling mode; and
heats the motor by exposing the hot air of the second coolant heated by exchanging heat with the first coolant to the motor during the heating mode.

9. The composite thermal management system of claim 8, wherein the first heat exchanger includes:
a first coolant line that is connected to the chiller, and has the first coolant cooled or heated by exchanging heat with the refrigerant flowing into the chiller, circulating therethrough;
a first coolant storage tank that is installed in the first coolant line, and stores the first coolant flowing into the first coolant line; and
a first coolant circulation pump that is installed in the first coolant line and circulates the first coolant in one direction.

10. The composite thermal management system of claim 9, wherein the first heat exchanger further includes a battery heating and cooling unit that is equipped with the battery and cools or heats the battery by exposing the first coolant, which is heat-exchanged with the second coolant, to the battery.

11. The composite thermal management system of claim 10, wherein the second heat exchanger includes:
a second coolant line that is connected to the first coolant line, and has the second coolant, which is cooled or heated by exchanging heat with the first coolant flowing into the first coolant line, circulating therethrough;
a heat exchange module that is installed in the second coolant line, connected to the first coolant line, and cools or heats the second coolant flowing thereinto by exchanging heat with the second coolant and the first coolant introduced thereinto;
a radiator that is installed in the second coolant line, and discharges the cold air or the hot air of the second coolant passing through the heat exchange module to the outside space, or cools or heats the battery with the cold air or the hot air of the second coolant;
a second coolant storage tank that is installed in the second coolant line, and stores the second coolant passing through the radiator;
a second coolant circulation pump that is installed in the second coolant line and circulates the second coolant in one direction; and
a motor heating and cooling unit that is equipped with the motor and exposes the motor to the second coolant passing through the radiator to cool or heat the motor.

12. The composite thermal management system of claim 11, wherein the first coolant line includes:
a main coolant line that is connected to the chiller and has the first coolant storage tank and the first coolant circulation pump installed therein;
a first branch line that is branched in a first direction from the main coolant line, connected to the first coolant circulation pump, and has the battery heating and cooling unit installed therein; and
a second branch line that is branched in a second direction from the main coolant line, arranged parallel to the first branch line, connected to the first coolant circulation pump, and has the battery heating and cooling unit installed therein, and
the second heat exchanger is arranged in the first branch line and the second branch line, respectively.
